(19) United States
(12) Patent Application Publication
(10) Pub. No.: US 2003/0089534 A1
(43) Pub. Date: May 15, 2003

(54) Tracked vehicle with a drive system

(76) Inventors: Helmut Kanzler, Vohringen (DE); Michael Kuhn, Achstetten (DE); Stephan Mayer, Munderkingen (DE)

Correspondence Address: GREENBERG TRAURIG, P.C., 77 WEST WACKER DRIVE, CHICAGO, IL, 60601-1732, US

(21) Appl. No.: 10/281,403

(22) Filed: Oct. 25, 2002

(30) Foreign Application Priority Data
Oct. 30, 2001 (DE) 10154651.3-21

(51) Int. Cl. B62D 6/00

(52) U.S. Cl. 180/6.2; 180/403

(57) ABSTRACT

A tracked vehicle with a drive system, with a steering function operating element, and with a driving function operating element, which operating elements are in working connection with the drive system. According to the invention, the steering function operating element and/or the driving function operating element is designed as a set-point adjuster for the electronic actuation of a corresponding steering function module and/or a corresponding driving function module of the drive system.

### BACKGROUND OF THE INVENTION

The invention pertains to a tracked vehicle with a drive system, with a steering function operating element, and with a driving function operating element, which operating elements are in working connection with the drive system.

Tracked vehicles which are used to groom ski slopes are known in general. A tracked vehicle of this type has a chain drive on each of two opposite sides, each being driven by its own hydrostatic drive. The hydraulic system required for the drives is supplied by at least one pump device, which is driven by an internal combustion engine. A gas pedal, serving as a driving function operating element, is connected by a Bowden cable to the internal combustion engine, so that the actuation of the gas pedal causes the speed of the internal combustion engine to increase or decrease. In addition, a steering wheel is provided in the area where the driver sits to serve as a steering function operating element. This steering wheel is connected hydraulically to the hydrostatic drives of the two chain drives in such a way that the applied steering movements produce different drive speeds in the opposing chain drives. As a result, the path along which the tracked vehicle travels will curve.

### SUMMARY OF THE INVENTION

The task of the invention is to create a tracked vehicle of the type indicated above which offers improved driving convenience.

This task is accomplished in that the steering function operating element and/or the driving function operating element is designed as a set-point adjuster for the electronic actuation of a corresponding steering function module and/or of a corresponding driving function module of the drive system. As a result of the solution according to the invention, the steering function operating element and/or the driving function operating element is completely disconnected either mechanically or hydraulically from the drive system. The only working connection between the steering function operating element or the driving function operating element and the drive system is electronic. Because the steering function module and the driving function module of the drive system are actuated by purely electronic means, it is possible significantly to increase both the operating convenience and the efficiency and accuracy of the steering function module and of the driving function module and to improve other properties as well. It is possible to prepare a plurality of different input-output maps for different driving situations and to actuate the steering function module and the driving function module according to these input-output maps. One or more microprocessors are preferably provided, which can be programmed by entering the corresponding input-output maps, as a result of which the steering function module and the driving function module can be actuated on the basis of intelligent computing processes.

As an elaboration of the invention, a sensor means for detecting operating movements is assigned to the steering function operating element and/or to the driving function operating element, each of these sensor means being connected by at least one electronic data transmission line to an electronic control unit; the steering function module and the driving function module are provided with sensors for detecting actual values of the steering and driving processes; and the electronic control unit is provided with evaluation means, which actuate the steering function module and the driving module as a function of a predetermined nominal/actual value input-output map. The nominal/actual input-output map represents a map in which each set point specified by the steering or driving function is associated with a certain type of actuation of the steering function module and/or of the driving function module, the specific type of actuation being determined on the basis of the desired and predetermined driving and steering situations. Whether the actuation does in fact lead to the desired, predetermined value is determined by comparing the nominal value continuously with the detected actual value of the steering function module or of the driving function module.

As a further elaboration of the invention, a steering function component comprising the steering function operating element and the steering function module and/or a driving function component comprising the driving function operating element and the driving function module is designed with redundancy. The redundant design ensures a high degree of functional reliability. In addition, the redundant design also makes it possible for the tracked vehicle to obtain approval for highway operation.

As a further elaboration of the invention, the sensor means detects certain variables of the physical motion of the operating elements. In particular, such sensors can detect changes in the angle of the steering wheel serving as the steering function operating element or changes in the distance traveled by the gas pedal serving as the driving function operating element. It is preferable for these variables to be detected as a function of time, so that the system can recognize whether the steering wheel or the gas pedal is being moved quickly or slowly. This makes it easier for the driver to recognize the dynamics of the movement of the vehicle.

As a further elaboration of the invention, the nominal/actual input-output map for the driving function module and/or for the steering function module is set up in such a way that the detected physical variables of the motion of the set-point adjusters, especially intervals of distance, angle and/or time, are transmitted not in linear fashion but rather in parameterized form to the steering function module and/or to the driving function module, especially as a function of the driving speed of the tracked vehicle. As a result, it is possible for the tracked vehicle to be steered indirectly and for the steering processes to be carried out more safely, especially at high speeds, even when the driver is relatively inexperienced. Thus, for example, it is possible for the distance which the pedal travels to be increased in the lower speed ranges and decreased in the higher speed ranges, so that a driver has a better feeling for the acceleration or deceleration of the tracked vehicle at slower speeds.

It is advantageous for the turning radii assigned to the angles or distances of the steering movements to be larger at higher speeds than at lower speeds. This ensures a sufficient degree of driving safety even when the steering wheel is turned sharply at higher speeds.

As a further elaboration of the invention, a steering force simulator, which is tuned to the dynamic driving properties of the steering function component, is assigned to the steering function operating element. As a result, it is possible in particular for a counterforce to be exerted during a steering movement to provide the driver with a better feeling for the steering process. As a result, the feel of driving a tracked vehicle can be made similar to the feel of driving a passenger vehicle. The generation of appropriate counterforces or countertorques also prevents the steering movements from being made more quickly than the steering function module can be actuated in response.

As a further elaboration of the invention, the steering movements of the steering function operating element are transmitted in parameterized form as a function of the turning radius of the tracked vehicle or as a function of a reaction time of the steering function module. As a result, the driver of the tracked vehicle obtains a better feel for the driving situation at the time in question and also an improved sense of the dynamics of the vehicle's movement.

As a further elaboration of the invention, function monitoring means, which are connected to the electronic control unit, are assigned to the steering function component and/or to the driving function component, and an error map is stored in the evaluation unit, which, upon failure of a redundant component, enables an emergency driving mode for the drive system. Upon failure of a redundant component, a so-called “limp-home” mode can be enabled, which allows the tracked vehicle to continue to be driven but at a much reduced maximum speed. The goal here is to make it possible for the tracked vehicle to be driven to the nearest garage for repairs.

As a further elaboration of the invention, driving status sensors, which detect the instantaneous driving status of the tracked vehicle, are connected to the electronic control unit, and a driving stability program, which actuates functional components of the drive system as a function of the detected instantaneous driving status, is stored in the evaluation unit. These types of driving stability programs are already known in and of themselves in the area of passenger vehicles. The driving status sensors can in particular be yaw sensors or transverse acceleration sensors. The data concerning yaw angles or transverse accelerations can be used together with corresponding data on driving speed, steering angle, steering speed, gas pedal or brake pedal position, and engine rpm's or similar data as a basis on which a corresponding evaluation algorithm can run tests to determine whether the driving situation is still within the allowable limits of stable driving dynamics. If necessary, suitable countermeasures can be implemented in the form of the electronic actuation of the various drive components. In contrast to wheeled vehicles such as passenger cars, appropriate countermeasures do not take the form of the actuation of the brake but rather the equally rapid form of the actuation of the hydraulic drive system, especially by means of the rapid pivoting of the left or right propulsion pump, which is part of the associated hydraulic drive system assigned to the chain drive on the left or right side.

As a further elaboration of the invention, sensor means are provided for the simultaneous detection of the drive speeds of the chain drives on both sides. The electronic control unit can then evaluate the data transmitted from the sensor means to ensure that the two chain drives are operating in synchrony with each other as a function of the position to which the steering function operating element has been moved at the moment in question. As a result, the tracked vehicle can be driven straight ahead safely even at high speeds. In addition, the actual turning radius being traveled and the different chain operating speeds on the two sides of the vehicle can be coordinated in such a way as to eliminate almost completely the slip which can occur between the chains and the ground over which they are traveling.

As a further elaboration of the invention, the driving function operating element is equipped with damping means. The idea behind this measure is to prevent the slight movements of the foot on the gas pedal which can occur when the vehicle is subjected to vibrations from leading to corresponding accelerations or decelerations of the tracked vehicle. The damping means are preferably implemented in electronic form.

As a further elaboration of the invention, locking functions are stored in the electronic control unit to lock out predetermined operating functions in defined driving situations, either optionally or automatically. As a result, it is possible in particular to lock out highly dynamic driving maneuvers such as driving with the chains moving in opposite directions at full steering wheel deflection. It is also possible to turn off a corresponding driving stability program, if desired. It is essential that the locking functions, which lock out only highly dynamic driving maneuvers, be designed so that they can also be turned off again, that is, released, so that each driver can mark out for himself the limits within which he is allowed to operate the vehicle.

### BRIEF DESCRIPTION OF THE FIGURES

Additional advantages and features of the invention can be derived from the claims and from the following description of a preferred exemplary embodiment of the invention, which is illustrated on the basis of the drawings:

FIG. 1 shows a schematic, block circuit diagram of a drive system for an embodiment of a tracked vehicle according to the invention.

FIG. 2 shows a characteristic curve of a driving function component of the drive system according to FIG. 1.

FIG. 3 shows a characteristic curve of a steering function component of the drive system according to FIG. 1.

FIG. 4 shows schematically a side view of an embodiment of a tracked vehicle according to the invention equipped with a drive system according to FIGS. 1-3.

### DETAILED DESCRIPTION OF THE DRAWINGS

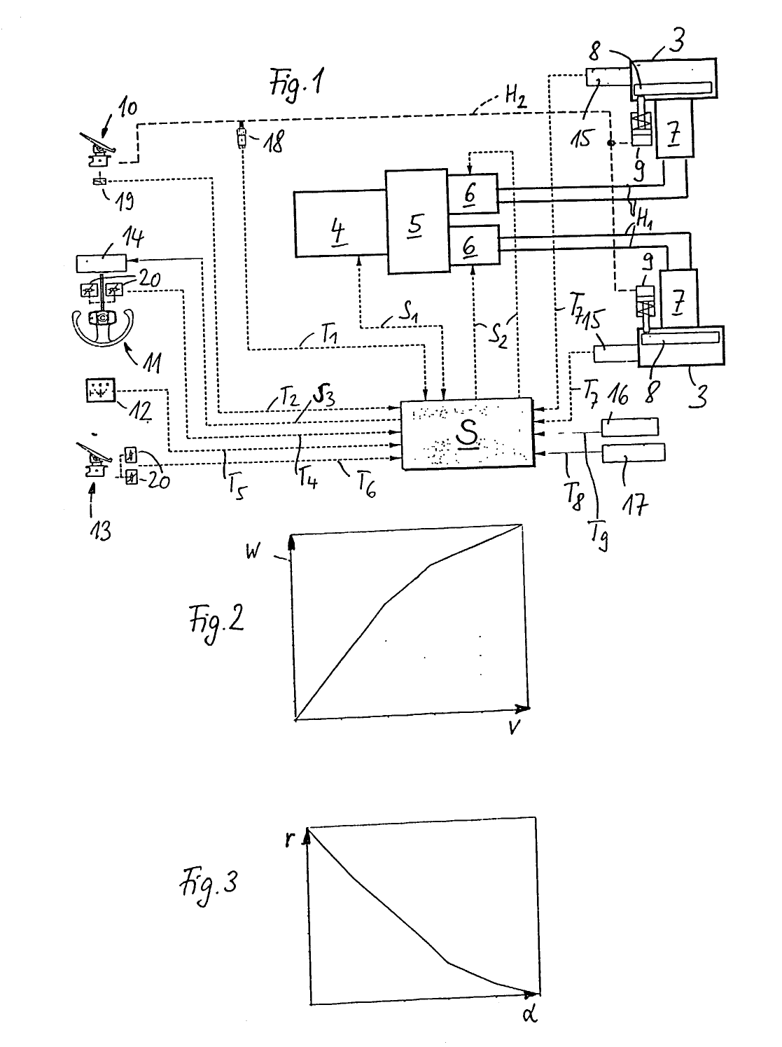

A tracked vehicle 1 according to FIG. 4 is a motor vehicle for conveying several people in the manner of a passenger car. The tracked vehicle 1 is provided on each of its two opposite sides with a revolving belt drive 2, each of which is driven by a tumbler wheel 3. Each tumbler wheel 3 is driven by a hydraulic motor 7 (FIG. 1) of a hydraulic drive system, acting by way of a transmission (not shown). The hydraulic motors 7 are part of a drive system which will be described in greater detail below with the help of the diagrams in FIGS. 1-3.

The hydraulic drive system is built separately for each side of the chain drive. Each side of the chain drive has a hydraulic propulsion pump 6, which is connected by a hydraulic circuit H₁ to the associated hydraulic motor 7 on the side of the vehicle in question. The propulsion pumps 6 for the two chain drive sides are hydraulic pumps known essentially in and of themselves and can be pivoted outward in continuously variable fashion all the way to full load. In a corresponding manner, each hydraulic motor 7 can also be controlled in continuously variable fashion via the corresponding hydraulic circuit H₁, so that a continuously variable chain drive is present on each side of the vehicle. Both propulsion pumps 6 are driven jointly by a central internal combustion engine 4, a spark-ignition engine in the present case, acting by way of a power divider 5. During normal operation, driving is controlled electronically by a central, electronic control unit S, as will be described in greater detail below.

The drive system has several functional components for normal driving. A brake function component comprises a brake function operating element in the form of a brake pedal 10, an associated electronic brake function circuit with corresponding actuation modes for the hydraulic motors 7 on the two sides of the vehicle, and a hydraulic brake circuit H₂, which has a brake piston 9 on each side of the vehicle, each of these brake pistons acting on a multi-disk brake 8 located near each tumbler wheel 3.

A steering function component comprises a steering function operating element, i.e., a steering wheel 11 in the present case, and an associated electronic steering function circuit integrated into the central control unit S, including appropriate actuation modes for the propulsion pumps 6.

A driving function component comprises a driving function operating element, i.e., a gas pedal 13 in the present case, and an electronic driving function circuit integrated into the electronic control unit S, including appropriate actuation modes for the propulsion pumps 6 and the internal combustion engine 4.

The electronic driving function circuit and the electronic steering function circuit, together with all the corresponding ways in which the associated hydraulic drive system or the internal combustion engine 4 can be actuated, are referred to as the steering function module and the driving function module, respectively.

Beyond the previously described functional components, there are also additional actuation and driving program modes stored in the electronic control unit S, which will also be described in greater detail below.

The steering function component also includes a steering force simulator 14, which can exert counterforces or countertorques on the pivoting or rotating steering wheel 11, as will be described in greater detail below.

To initiate a braking operation, the driver of the tracked vehicle 1 will actuate the brake pedal 10, which is integrated hydraulically into the hydraulic circuit H₂. Normal braking decelerations occur through the corresponding actuation of the hydraulic motors 7, in that the control unit S pivots the propulsion pumps back inward to an appropriate extent. A pressure sensor 18, which is connected by a signal line T₁ to the control unit S, is installed in the hydraulic circuit H₂ to detect the increase in the brake pressure in the hydraulic circuit H₂ caused by the actuation of the brake pedal 10. By way of signals traveling over appropriate control lines S₂, the propulsion pumps 6 are actuated synchronously by the electronic brake function circuit so that the hydraulic motors 7 are slowed down to effect the desired deceleration of the vehicle. Near each tumbler wheel 3 there is a speed sensor 15, which detects the actual rpm's of the tumbler wheel and transmits this value to the control unit S. This makes it possible for the brake function to be controlled automatically; that is, when the brake pedal 10 is actuated, the desired brake function is achieved by continuous comparison of the actual with the nominal values and by the use of the input-output map predetermined by the electronic brake function circuit. The speed sensors 15 are connected to the electronic control unit S by signal lines T₇.

Up to a predetermined system pressure in the hydraulic circuit H₂, the brake function is transmitted to the hydraulic motors 7 electronically, that is, by detection of the set-point value by means of the pressure sensor 18 and by electronic actuation of the propulsion pumps 6. In the present exemplary embodiment, the threshold value for the pressure up to which the previously described brake function control takes place is approximately 15 bars. When the pressure in the hydraulic circuit H₂ exceeds 15 bars, pushing down on the brake pedal 10 hydraulically actuates the multi-disk brake 8. This hydraulic actuation can occur either as an alternative or in addition to the actuation of the hydraulic motors 7. The brake pistons 9 are spring-loaded in the release direction so that they are inoperative until the previously described pressure threshold value of approximately 15 bars is reached. The multi-disk brakes 8 are therefore also in the released or rest position below the threshold pressure value.

The steering wheel 11 is connected to the electronic control unit S by electronic means only. Movements of the steering wheel are detected by two potentiometers 20, which transmit the corresponding pivot angles associated with the turning of the wheel as set-point values to the electronic control unit. The deflections of the steering wheel are transmitted in redundant fashion. On the basis of a nominal/actual input-output map stored in the control unit S, which is part of the electronic steering function circuit, the propulsion pumps 6 are actuated as required via the control lines S₂. Depending on the deflection of the steering wheel, one of the propulsion pumps 6 is pivoted inward, the other outward, so that the chain on one side of the vehicle slows down and the chain on the other side speeds up correspondingly. Of course, the process can also be carried out so that only one of the two propulsion pumps 6 is actuated, with the result that the speed of the chain increases or decreases on only one side of the vehicle.

To give the driver of the tracked vehicle a feel for the terrain over which the vehicle is traveling, i.e., a feel similar to that familiar from riding in a wheeled vehicle, a steering force simulator 14, which, to a limited degree, produces the familiar types of reaction forces or steering forces, is assigned to the steering wheel 11. The steering force simulator 14 can be designed as an electric motor, as a hydraulic damping element, or as a brake unit. The simulator is actuated by the control unit S via a control line S₃ as a function of the associated evaluation of the pertinent nominal and actual values of the corresponding steering function module. The steering force simulator 14 is designed in particular so that, as a function of the speed at which the steering wheel 11 is turned, a countertorque is applied as soon as the steering wheel is moved faster than the vehicle can follow, given the dynamics of its own movement. The appropriate countertorque is applied, therefore, whenever the steering wheel is turned faster than the allowed pivot time of the corresponding hydraulic propulsion pump 6. This is intended in particular to make it impossible for the steering wheel to be jerked violently in one direction or the other. Of course, the steering force simulator 14 can also apply counterforces to serve other functions, depending on the types of steering situations which are to be provided with appropriate countertorques. An appropriately modified input-output map can be programmed and stored in the electronic control unit S to provide the required type of actuation.

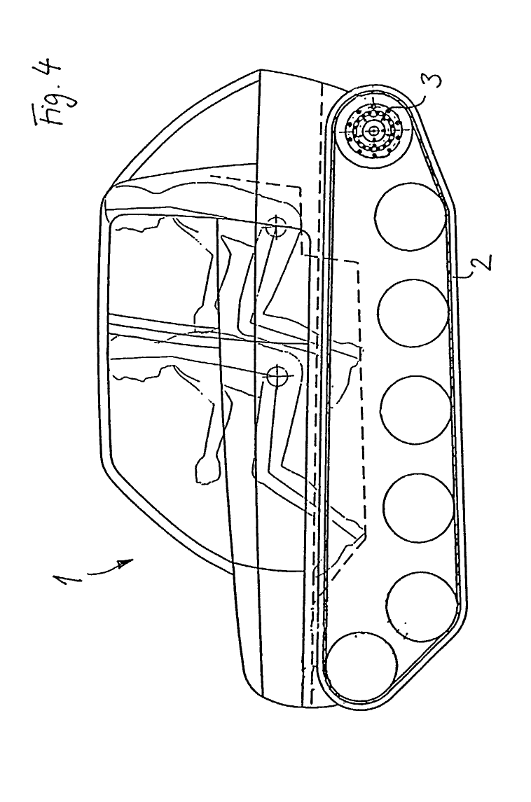

In addition, the input-output map of the electronic steering function circuit is parameterized as a function of velocity in such a way that steering is implemented more indirectly at higher velocities, preferably at velocities of more than 25 km/h, than at slower velocities between 0 and 25 km/h. FIG. 3 shows a parameterized steering curve of this type. The turning radius r being traversed by the tracked vehicle 1 is plotted on the ordinate, the steering angle a of the steering wheel 11 on the abscissa.

In cases where the steering characteristic is parameterized as a function of velocity, it is preferable to provide several of these characteristic curves and to interpolate between them. Three characteristic curves are preferably provided, one for each of three different vehicle velocities, especially for velocities of v₁=0, v₂=5 km/h, and V₃=maximum speed. Curves of this type with the appropriate characteristics can take into account in particular the greater leakage losses which occur in the associated hydraulic drive system at low velocities and correspondingly higher power take-off torques. At high velocities, only very small differences in the volume rates-of-flow within the hydraulic circuits H₁ are sufficient to achieve the desired change in the course of the tracked vehicle.

The described steering function module thus makes it possible to establish a variable correlation, adjusted according to the driving situation at the moment in question, between the steering angle of the steering wheel 11 and the corresponding pivot angle of the propulsion pumps 6, as a result of which the driver can drive and steer the vehicle safely and confidently at both low and high velocities.

The gas pedal 13 of the driving function component of the drive system is also connected exclusively by electronic means to the electronic control unit S and thus to the internal combustion engine 4 or to the associated hydraulic drive system 6, 7. Like the steering wheel 11, the gas pedal 13 also acts as a set-point adjuster, in that corresponding actuations of the gas pedal are detected by a potentiometer 20 and transmitted over a signal line T6 to the electronic control unit S. The movements of the gas pedal are also detected in redundant fashion. For this purpose, two potentiometers 20 are provided for the gas pedal 13, as also in the case of the steering wheel design.

Also assigned to the driving function module is a driving direction switch 12, which is connected to the control unit 6 by a signal line T₅, and which is used to specify the desired travel direction, that is, either forward or backward. The electronic driving function circuit has several input-output maps, which, in addition to the detected the driving pedal set-points, receive in particular the actual driving speed values via the two speed sensors 15, feedback from the internal combustion engine 4 via the control and signal lines S1, and feedback (not shown) concerning the corresponding instantaneous pivot angles of the propulsion pumps 6. In addition, several vehicle status sensors are provided, in the present case a yaw angle sensor 16 and a transverse acceleration sensor 17, which are connected to the electronic driving function circuit within the control unit S by way of signal lines T₈ and T₉.

The gas pedal 13 specifies the nominal speed of the vehicle. By appropriate adjustment of the engine rpm's of the internal combustion engine 4 and of the pump pivot angle of each of the two propulsion pumps 6, the selected driving speed is achieved by the electronic control system, acting via the control unit S.

In the case of a preferred variant, when it is desired to start up the tracked vehicle 1 from a dead stop, the internal combustion engine 4 is first revved up beyond idle into a speed range which ensures especially good efficiency. The propulsion pumps 6 are pivoted outward to a degree which corresponds to the desired driving speed. As soon as the propulsion pumps 6 have been pivoted all the way out, the rpm's of the internal combustion engine 4 are increased until the maximum speed is reached. The electronic driving function circuit of the control unit sets a nominal rpm value for the electronic engine control circuit of the internal combustion engine 4 (not shown), and the engine control circuit automatically adjusts the rpm's to match this value regardless of the load.

Via the signal line T₆, data on the actuation of the gas pedal 13 as a function of time are also received by the control unit S. As a result, the driver's wish for fast or slow acceleration can be detected and realized by the electronic driving function circuit. Small movements of the pedal are electronically damped by the control unit S, because such slight movements of the driver's foot can arise unintentionally as a result of vibrations of the vehicle. Like the steering characteristic, the gas pedal characteristic is also parameterized to convey to the driver a better feel for the dynamics of driving. Thus, a corresponding input-output map of the electronic driving function circuit can be stored in the system such that, to achieve the same change in velocity, the gas pedal must be pushed down farther at slow velocities than it does at high velocities. It is also possible as an alternative to provide velocity ranges between which it is possible to switch, e.g., preferably a first velocity range of 0-25 km/h and a second velocity range of 0-50 km/h. The full range of pedal travel is assigned to each of the two velocity ranges. This has the result of improving the resolution of pedal travel at low velocities. A gas pedal characteristic parameterized in this way is shown in FIG. 2. Here the pedal travel w is plotted on the ordinate, the velocity v of the vehicle on the abscissa.

The electronic driving function circuit also contains a constant-speed controller, especially for precise straight-ahead travel even at high velocities. Because the rpm's of the tumbler wheels 3 are detected, it is possible to monitor whether or not the speeds of the chains on the two sides of the vehicle correspond exactly to the set-point defined by the deflection of the steering wheel 11. That is, it is possible to determine, for example, that the two chains are moving at exactly the same speed, as they should be when the vehicle traveling straight ahead. A reset centering function is preferably provided for the steering wheel 11, which keeps the steering wheel 11 centered in the zero position, preferably by the force of a spring.

If and when the redundantly designed steering function component or the redundantly designed driving function component fails, the electronic control unit S switches the vehicle over to emergency operating mode, which is also referred to as “limp-home” mode. As a result, it is possible for the vehicle to be driven at reduced speed to the nearest garage for repairs.

As previously explained, the electronic driving function circuit receives information on the driving speed, the steering wheel angle, the speed of steering wheel actuation, the positions of the gas pedal and brake pedal, the engine rpm's, the pump pivot angles of the propulsion pumps 6, and the yaw angle or transverse acceleration of the vehicle. A driving stability program stored in a corresponding input-output map of the electronic driving function circuit is supplied with these data. The program calculates whether the values just detected are still within the allowable limits which represent stability in terms of vehicle dynamics. As soon as this is no longer the case, electronic countermeasures are initiated. In contrast to wheeled vehicles, the intervention does not take the form of actuating the brakes on the wheels but rather the form of rapidly pivoting the left and/or the right propulsion pump 6.

There are also locking functions In the electronic driving function circuit. Thus, for example, it is possible to lock out highly dynamic driving maneuvers, such as especially the operation of the chains in opposite directions at full deflection of the steering wheel. This type of locking occurs preferably by way of key switches. It is also possible, as an alternative, to use this type of key switch to turn off the driving stability program so that even highly dynamic driving maneuvers can also be performed.

What is claimed is:

1. A tracked vehicle with a drive system, with a steering function operating element, and with a driving function operating element, which operating elements are in working connection with the drive system, characterized in that the steering function operating element (11) and/or the driving function operating element (13) is designed as a set-point adjuster for the electronic actuation of a corresponding steering function module and/or of a corresponding driving function module of the drive system.

2. A tracked vehicle according to claim 1, characterized in that a sensor means for detecting operating movements is assigned to the steering function operating element (11) and/or to the driving function operating element (13), this sensor means being connected by at least one electronic data transmission line (T₄, T₅) to an electronic control unit (S); in that the steering function module (11) and the driving function module (13) are provided with sensors (15) for detecting actual values of the steering and driving processes; and in that the electronic control unit (S) is provided with an evaluation unit, which actuates the steering function module and the driving function module as required as a function of a predetermined nominal value/actual value input-output map.

3. A tracked vehicle according to claim 1, characterized in that a steering function component comprising the steering function operating element (11) and the steering function module and/or a driving function component comprising the driving function operating element (13) and the driving function module is designed with redundancy.

4. A tracked vehicle according to claim 2, characterized in that the sensor means detect physical variables of the motion of the operating elements.

5. A tracked vehicle according to claim 2, characterized in that the nominal value/actual value input-output map for the driving function module and/or for the steering function module is designed so that the detected physical variables of the motion of the set-point adjusters, especially intervals of distance, angles, and/or times, are transmitted not in linear fashion but rather in parameterized fashion, especially as a function of the driving speed of the tracked vehicle, to the steering function module and/or to the driving function module.

6. A tracked vehicle according to claim 1, characterized in that a steering force simulator (14), which is tuned to the dynamic properties of the steering function component, is assigned to the steering function operating element.

7. A tracked vehicle according to claim 6, characterized in that the steering movements of the steering function operating element (11) are transmitted after they have been parameterized as a function of the turning radius of the tracked vehicle (1) or as a function of a reaction time of the steering function module.

8. A tracked vehicle according to claim 3, characterized in that function-monitoring means are assigned to the steering function component and/or to the driving function component, which monitoring means are connected to the electronic control unit (S); and in that, in the evaluation unit, an error map is stored, which, when one of the redundant components fails, enables an emergency driving mode of the drive system.

9. A tracked vehicle according to claim 1, characterized in that driving status sensors (16, 17) are provided, which are connected to the electronic control unit (S) and detect instantaneous driving states of the tracked vehicle (1), and in that a driving stability program is stored in the evaluation unit, which program actuates functional components of the drive system as a function of the detected instantaneous driving states.

10. A tracked vehicle according to claim 2, characterized in that the electronic control unit (S) evaluates data received from the sensors (15); and in that the chain drives of the two sides of the vehicle are operated in synchrony with each other as a function of the position to which the steering function operating element (11) has been moved at the moment in question.

11. A tracked vehicle according to claim 1, characterized in that damping means are provided for the driving function operating element (13).

12. A tracked according to claim 2, characterized in that locking functions are stored in the electronic control unit (S) to lock out predetermined operating functions in defined driving situations either optionally or automatically.
